(19) United States
(12) Patent Application Publication
(10) Pub. No.: US 2011/0170283 A1
(43) Pub. Date: Jul. 14, 2011

(54) Solar Powered Led Street Lamp With Automatic Light Control

(76) Inventor: Sze Keun Chan, Hongkong (CN)

(21) Appl. No.: 11/913,933

(22) PCT Filed: May 9, 2006
(86) PCT No.: PCT/CN2006/000920

§ 371 Date: May 7, 2008

(30) Foreign Application Priority Data
May 9, 2005 (CN) 20050018060.2

(51) Int. Cl. F21L 4/00

(52) U.S. Cl. 362/183

(57) ABSTRACT

A solar powered LED street lamp with automatic light control includes a solar photovoltaic board, a brightness/darkness detection sensor, a lamp pole, an LED lamp, an LED direction board, billboard or light box, a base, a storage battery, a central controller and an infrared motion sensor. The solar photovoltaic board is mounted on the top end of the lamp pole, the LED direction board, billboard or light box is mounted on the lamp pole, the storage battery and the central controller are situated in the base, the motion sensor and the LED lamp are mounted on the transverse bar of the lamp pole, and a plurality of LEDs are arrayed so as to constitute the characters or text on the LED direction board, billboard or light box.

### CROSS REFERENCE TO RELATED APPLICATIONS

This national phase entry application claims priority to international application PCT/CN2006/000920 filed on May 9, 2006, and Chinese application 200520018060.2 filed on May 9, 2005, which are incorporated herein by reference.

### TECHNICAL FIELD

This invention relates to a solar powered LED streetlight and more particularly to an LED streetlight, which has direction a board or billboard or light box, a brightness and darkness auto-adjustment function and can use solar as its power source.

### BACKGROUND ART

Typical streetlight use electric utility distribution grid power to power the lamp bulb. There are some streetlights that utilize solar power as a power supply. Because the power consumption of a generic lamp is fairly high, the solar power collected in the daytime cannot supply all energy needed at night another power source is needed as a supplement. Moreover, the streetlight stays lit all night even when no one is present so that light is not needed, which will thereby shorten the life of the lamp bulb. Thus the current streetlight does not achieve a goal of 100% energy savings.

LEDs have the advantage of a long life, high luminance, null radiation, no high strike voltage needed for start-up and low power consumption. It is a “green” power saving technology in comparison to conventional streetlights.

In addition, present roadside directional signs and guide posts are typically made from reflective materials that function by reflecting external light, such as, for example, light from a street lamp. Moreover, electronic bulletin boards and some commercial billboards need to be set up on a separate pole or stand rack.

### SUMMARY

It is, therefore, an object of the invention, to solve the present technical shortage or problems and to provide a kind of green, solar-powered streetlight, which has a billboard, direction board or other type of light box with LED lighting and which has a long lifetime. The streetlight can be used on road and residential areas.

It is another object of the invention to provide a lighting or light sensor, which will sense the lighting conditions, sending a signal to a central controller to automatically turn the streetlight on or off.

It is another object of the invention to provide a human body detector, such as, for example a motion sensor, which will send signal to the central controller, to adjust the light to a low brightness status when nobody is in the detection area, or to adjust the light to high brightness status when somebody is in the detection area. Because the light brightness can change, it reduces wasted power and makes good use of the solar power collected in the daytime while no supplemental power is needed. Because the life of LED will not be influenced by brightness adjustments, this overall increases the life time of lamp.

It is another object of the invention to install the direction board, billboard or light box on the lamp pole.

These objects are accomplished by a solar photovoltaic board, a light sensor, a lamp pole, an LED lamp, an LED direction board, billboard or light box, a base with a storage battery inside, a central controller and a human body detector, such as, for example, a motion sensor. The solar photovoltaic board is mounted on the top end of the lamp pole, the LED direction board, billboard or light box is mounted on the lamp pole or the lamp pole itself is designed to be a direction board, billboard or light box, the storage battery and the central controller are situated in the base, the motion sensor and the LED lamp are mounted on the transverse bar of the lamp pole, the direction board or billboard or light box is also mounted with a photovoltaic board and a plurality of LEDs that are arrayed so as to constitute the characters or the marks on the LED direction board, billboard or light box.

The photovoltaic board collects solar power and when the light turns on in the night, the photovoltaic board on the direction board, billboard or light box continues to collect LED light power. The solar module will charge the storage battery via diode D1 and normally closed switch K2. When the central controller detects that the storage battery is full, it will connect switch K2 and K1, cut-out the charge circuit and connect load R, protecting the storage battery from an overcharge.

The light sensor configures the brightness/darkness threshold value. When the darkness threshold value is met, a signal will be sent to central controller, to connect switch K3. Then the power is on, lighting LED lamp and direction board, billboard or light box with low brightness and low power light. When the brightness threshold value is met, the signal will be sent to central controller, to disconnect switch K3. Then the power of the streetlight is turned off.

The motion sensor is used to detect a human body. When somebody is in the detection area, the detector will automatically send signal to central controller, the controller will adjust the voltage and current from DC/DC converter, LED lamp and LED in the direction board or billboard or light box turns into high brightness status; when the person leaves the detection area, the lamp goes back to low brightness status. As time goes on, the capacity of the storage battery goes down, the central controller will adjust the voltage and current from the DC/DC converter until disconnecting switch K3 and connecting load R, which will prevent storage battery from over-discharge damage.

The LED can be replaced by LED microchip or any other lighting components. The invention can use generic power when removing solar module and re-allocating the brightness/darkness detection sensor on the top of lamp pole.

In one embodiment, a energy-saving LED is used as lighting source and is activated by a motion sensor. When there is nobody in the detection aria, particularly late at night, the light can be adjusted to a low brightness status. As a result, power is saved and solar power that is collected in the daytime is enough for the whole night without the need for other supplemental power. And, since a light sensor is used to automatically turn the streetlight on and off fewer human resources are needed for maintenance.

For a better understanding of the invention, the objects, characteristics and advantages of the invention, examples of various embodiments are described below and are illustrated in drawings.

### BRIEF DESCRIPTION OF THE DRAWINGS

FIG. 1 is a structure chart of a solar powered LED street lamp with automatic light control;

FIG. 2 is a circuit diagram of a solar powered LED street lamp with automatic light control;

FIG. 3 is a structure chart of an LED street lamp with automatic light control;

FIG. 4 is a structure chart of an embodiment of the solar powered LED street lamp with automatic light control; and

FIG. 5 is a structure chart of another embodiment of the solar powered LED street lamp with automatic light control.

Elements in the drawings and description are identified with the following numbers: 1—solar photovoltaic board; 11—solar module/solar panel; 2—light sensor; 3—lamp pole; 31—transverse bar of the lamp pole; 4—base; 5—LED lamp; 51—LED; 6—LED direction board, billboard or light box; 7—motion sensor; 8—storage battery; 9—central controller; 10—DC/DC converter; 61—solar photovoltaic board; 62—light sensor; 63—LED.

### DETAILED DESCRIPTION

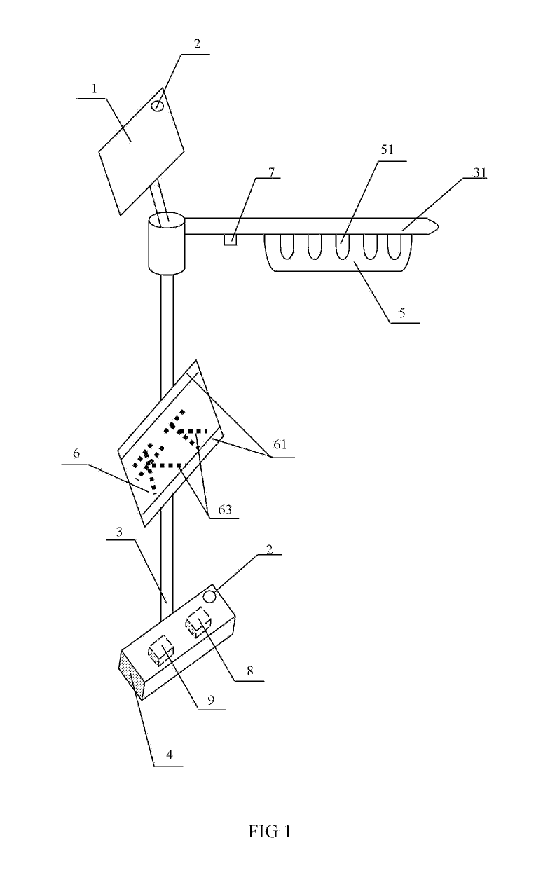

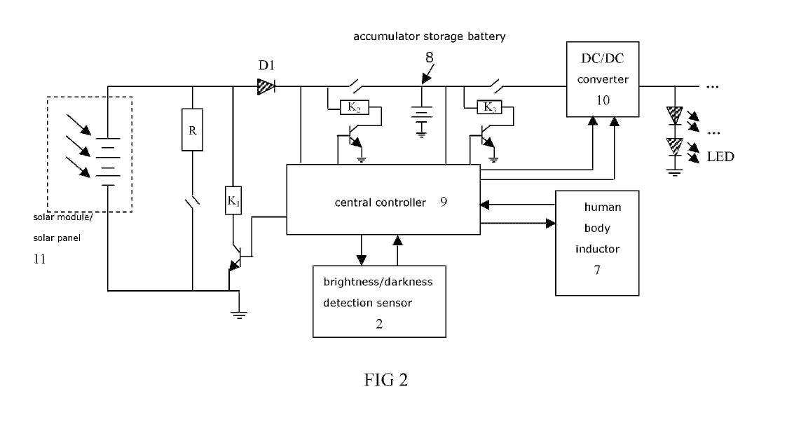

As shown in FIGS. 1 and 2, the system includes a solar photovoltaic board (1), a light sensor (2), a lamp pole (3), an LED lamp (5), an LED direction board, billboard or light box (6), a base (4) that encloses a storage battery (8), a central controller (9) and a motion sensor (7). The solar photovoltaic board (1) is mounted on the top end of the lamp pole (3), the LED direction board, billboard or light box (6) is mounted on the lamp pole (3) or the lamp pole (3) itself is designed to be the direction board, the storage battery (8) and the central controller (9) are situated in the base (4), the motion sensor (7) and the LED lamp (5) are mounted on the transverse bar (31) of the lamp pole, and a plurality of LEDs (63) are arrayed so as to display characters or text on the LED direction board, billboard or light box (6).

The solar photovoltaic boards (1 and 61) collect solar power and when the light turns on at night, the photovoltaic board (61) continues to collect light power from the LED lamp (5). The solar module (11) will charge the storage battery (8) via diode D1 and normally closed switch K2; when the central controller (9) detects that the storage battery is full, it will connect switch K2 and K1, cut-out the charge circuit and connect load R, protecting the storage battery (8) from an overcharge.

The central controller (9) can configure the on/off time or set up a time, like, after 12 o'clock midnight, the central controller (9) sends signal to alter the voltage and current from DC/DC converter (10), LED lamp (5) and LED (63) on the direction board or billboard or light box (6) turns to low brightness status. The central controller (9) can also send and receive wireless data.

Electric distribution grid power or other kind of power like wind power can also be used in the invention.

A light sensor (2) can be installed on both the solar photovoltaic board (1) and the base (4). The light sensor (2) can configure the brightness/darkness threshold value. When the darkness threshold value is met, a signal will be sent to the central controller (9) to connect switch K3. Then the power is on, lighting LED (51) in LED lamp (5) and LED (63) on the direction board (6) with low brightness and low power illumination. When the brightness threshold value is met, the signal will be sent to the central controller (9) to disconnect switch K3. Then the power to the streetlight is off.

The motion sensor (7) is used to detect a human body. When somebody is in the detection area, the detector (7) will automatically send a signal to central controller (9), the controller will adjust the voltage and current from DC/DC converter (10), LED lamp (5) and LED (63) in the direction board, billboard or light box turns to high brightness status; when the person leaves the detection area, LEDs are turned back to low brightness status. As time goes on, the capacity of the storage battery (8) goes down and the central controller (9) will adjust the voltage and current from DC/DC converter (10) until disconnecting switch K3 and connecting load R, which will prevent the storage battery from over-discharge damage.

The LEDs (51 and 63) can be replaced by LED microchips or any other lighting components.

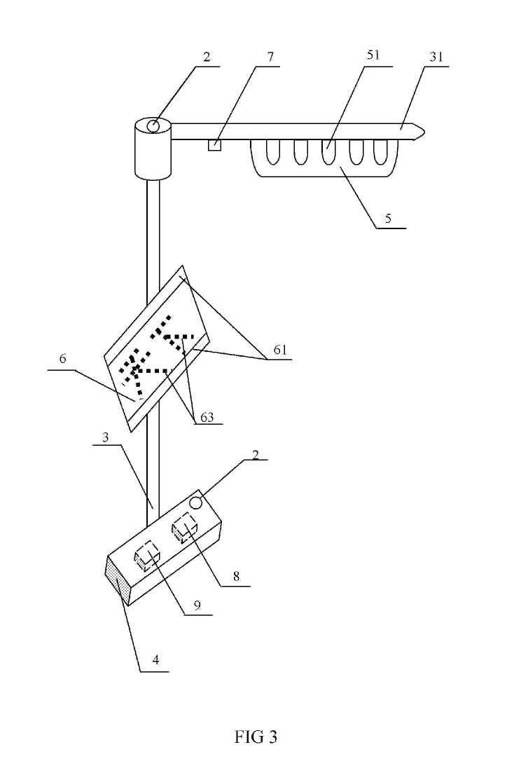

FIG. 3 illustrates a system without the solar photovoltaic board (1) and generic power is provided from the base (4). The light sensor (2) is installed on the top of lamp pole (3).

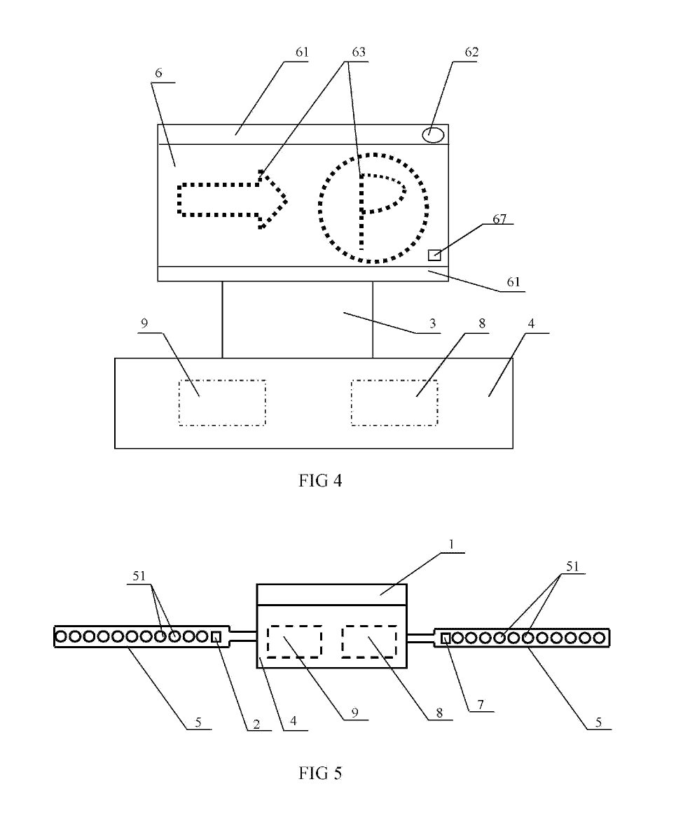

FIG. 4 illustrates another embodiment that includes: LED direction board, billboard or light box (6), solar photovoltaic board (61), light sensor (62), LED (63), lamp pole (3), base (4), motion sensor (7), storage battery (8), central controller (9). In an area such as a residential block, street center garden or building lawn area, where the need for lighting is relatively low, the LED lamp (5) can be removed while a plurality of LEDs (63), which are arrayed so as to constitute characters or text on the LED direction board, billboard or light box (6), can provide sufficient lighting. The solar photovoltaic board (61), light sensor (62), and motion sensor (7) are all installed on direction board or billboard or light box (6), and the central controller (9) is installed within the base (4). The electric power supply is the same as the embodiment illustrated in FIGS. 1 and 2.

FIG. 5 show another embodiment which includes: solar photovoltaic board (1), LED lamp (5), LED (51) in LED lamp (5), light sensor (2), motion sensor (7), storage battery (8), central controller (9) in base (4). The solar photovoltaic board (1) is installed on the base (4), the LED lamp (5) is made from soft transparent or translucent material, which is installed on the sides of base (4). The solar power LED streetlight can be installed on the road side or any place where lighting is needed.

The invention has practical value and meets the needs of a new type of lighting market, which is green, power-saving, elegant in appearance and convenient for mass production. While there have been shown and described above what are various embodiments of the invention, it will be apparent to those skilled in the art that various changes and modifications can be made herein without departing from the scope of the invention as defined by the claims.

What is claimed is:

1. A solar powered LED street lamp with an automatic light control, comprising:
a lamp pole with a top end and a bottom end;
a solar photovoltaic board attached to the top end of the lamp pole;
a light detection sensor mounted on the board;
a transverse bar attached to the top end of the lamp pole;
a lamp with a motion detector attached to the transverse bar;
a direction board or billboard attached to a mid-portion of the lamp pole, the direction board having a plurality of lights to provide a visual direction signal; and
a base attached to the bottom end of the lamp pole, the base enclosing a storage battery and a central controller.

2. The device of claim 1, wherein the solar module is connected to the storage battery and the central controller via a diode and a switch in a normally closed position.

3. The device of claim 1, wherein the light detection sensor is connected to the central controller.

4. The device of claim 1, wherein the motion sensor comprises an infrared human body inductor that is connected to the central controller.

5. The device of claim 1, wherein the lamp comprises one or more LED.

6. The device of claim 1, wherein the lamp comprises one or more LED chip.

7. The device of claim 1, wherein the lights on the direction board comprise LEDs.

8. The device of claim 1, wherein the lights on the direction board comprise LED chips.

9. The device of claim 1, further comprising:
an alternative power supply module to receive power from an electric power grid.
